(19) United States
(12) Patent Application Publication
(10) Pub. No.: US 2013/0095449 A1
(43) Pub. Date: Apr. 18, 2013

(54) DEVICE FOR DENTAL PROSTHESIS

(71) Applicant: Riccardo Montefusco, Bassano Del Grappa (IT)

(72) Inventor: Riccardo Montefusco, Bassano Del Grappa (IT)

(21) Appl. No.: 13/640,970

(22) PCT Filed: Apr. 13, 2011
(86) PCT No.: PCT/IB11/51592

§ 371 Date: Dec. 19, 2012

(30) Foreign Application Priority Data
Apr. 14, 2010 (IT) VR2010A000071

(51) Int. Cl. A61C 11/08

(52) U.S. Cl. CPC A61C 11/088
USPC 433/60

(57) ABSTRACT

A device adapted for adjusting the inclination of an entire articulator in relation to a support plane includes a support element on the support plane, a fastening device attached to the articulator, and a mechanism configured to adjust the distance between the fastening device and the support element.

The present invention relates to a device for dental prostheses, in particular an instrument for achieving parallelism between the bipupillar line and the occlusal plane.

The use of the articulator in fitting dental prostheses so as to keep the casts of the two dental arches in a suitable position, such as for example in U.S. Pat. No. 5,176,515 and U.S. Pat. No. 6,386,868 is known.

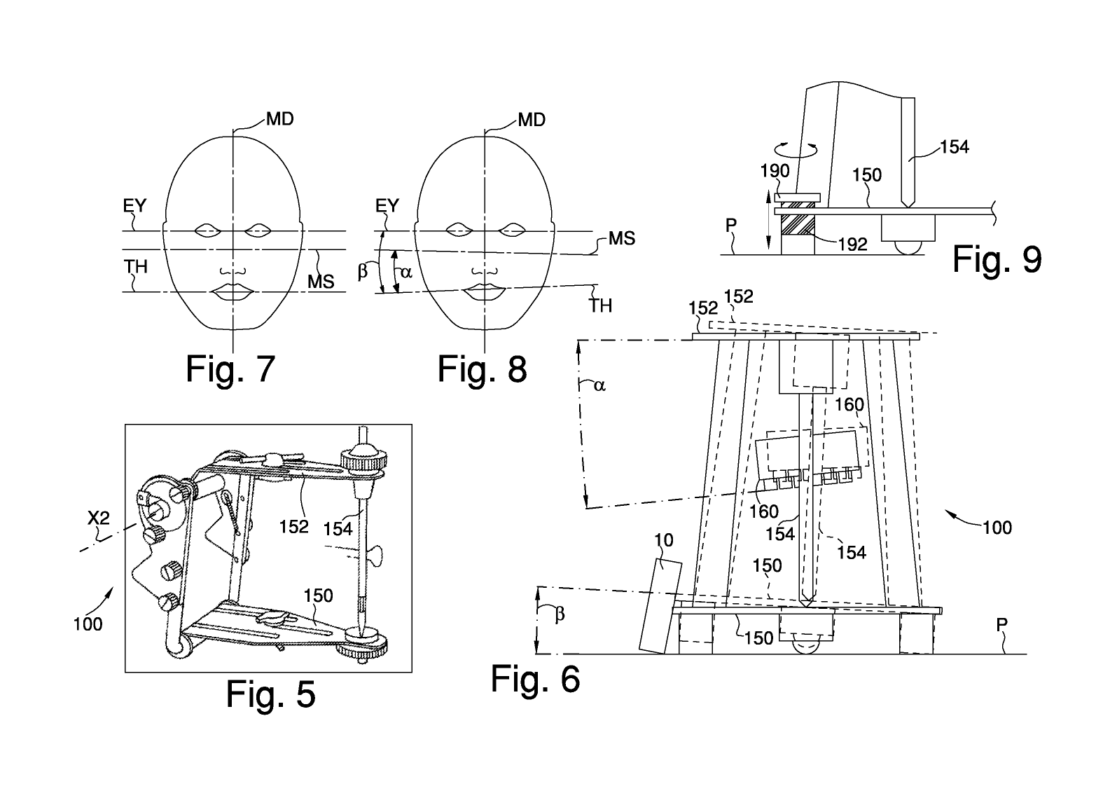

An articulator 100 (see FIGS. 5 and 6 below) is generally formed of a fixed base 150 to which an oscillating support 152 is hinged at a certain distance along an axis X2 which is adjustable in the space by means of known adjustment means. A positioning rod 154 completes control of the position.

The hinge along the axis X2 simulates the complex biomechanics of the mandibular articulation. The two casts of the dental arches, of which one indicated by reference numeral 160, are fixed between the support 152 and the base 150.

With the articulator various adjustments are possible to reproduce the movement between the two arches. Essentially the articulator is also used in combination with a facebow or transfer-bow for the correct stereometric measurement of the maxillary or occlusal plane. FIG. 7 shows an ideal face, symmetric in relation to a vertical median plane MD, where the axis (or plane) of the mandibular articulation MS, the bipupillar line EY and the occlusal plane TH are parallel to each other. Since perfect facial geometry is rare to find in nature, the facebow is used to position the maxillary plane and establish the angle 0°<α<90° between the MS plane and the TH plane measured from the patient in the dental clinic. The data is then transferred to the dental technician's lab and reproduced on the articulator, on which the prosthetic work is performed. Clearly the final purpose is to produce a dental prosthesis which respects mandibular biomechanics and aesthetics as far as possible. See FIG. 6 which uses a continuous line to show the articulator 100 while it reproduces and maintains the angle between the support 152 and the cast 160. In actual fact the inclination of the TH plane in the direction ear-nose is also reproduced on the articulator but we will overlook this aspect here and below inasmuch as not of interest.

In the book “Principles of Aesthetic Integration” by Claude R. Rufenacht, and in other works, the importance of the dentist's focus on strictly aesthetic aspects is emphasised. Basic parameters of attractiveness indicate that for a smile to be attractive it should, among other things, have an incisal plane (roughly the occlusal plane TH) parallel to the bipupillar line EY. Everyone diverges from the ideal parameters of FIG. 7, resembling FIG. 8, where the positions of the planes EY, MS and TH are not parallel to each other, and in this case not only is there a measurable angle 0°<α<90° between the plane MS and the plane TH, but also a measurable angle 0°<β<90° between the plane EY and the plane TH responsible for the attractiveness of the smile.

The articulator is designed to simulate the angle α in the laboratory but there is no articulator which simulates the angle β. In practice, the angle β is measured from the patient in the clinic using the facebow and then the dental technician laterally inclines the entire articulator by the same angle β using improvised or artificially added means such as for example plasticine placed by trial and error under the base 150.

Clearly, this and other rough systems are inaccurate, laborious and inconvenient. An accurate, versatile, reliable and economical system is therefore required.

The main object of the invention is to make a device for modelling dental prostheses which makes it possible to transfer the aesthetic information contained in the angle 0 to an articulator in a simple and precise manner.

Another object is to make a universal device applicable to any articulator.

Such objects are achieved by a device as defined in the appended claims.

The invention also relates to an articulator comprising means for inclining one side of the entire articulator in an adjustable manner in relation to a support plane so as to incline the models of prostheses insertable in the articulator to correct non-parallelism between the occlusal plane and the bipupillar line.

In addition, the invention also relates to a method of calibrating an articulator as defined above, comprising the steps of:
measuring the angle of non-parallelism between the occlusal plane and bipupillar line on a patient;
acting on such means to incline one side of the articulator substantially by said angle.

The invention also refers to an articulator accessory, separate from the articulator and able to be combined with it to lend the articulator new functions.

Further characteristics and advantages of the invention will be more clearly evident from the description of an example of the device according to the invention, together with the appended drawings wherein:

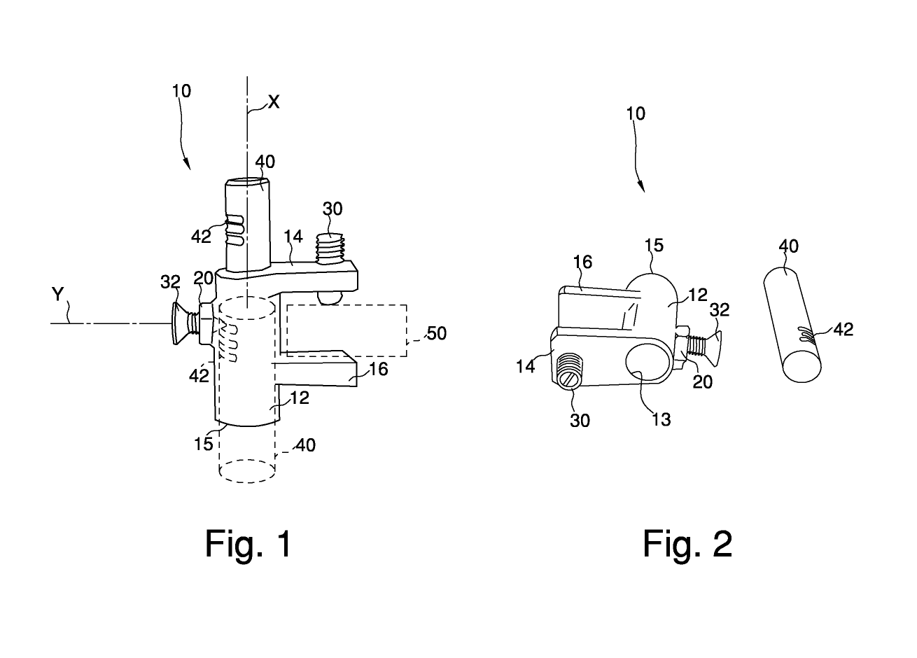

FIG. 1 shows a three-dimensional view of a device according to the invention as assembled;

FIG. 2 shows a three-dimensional view of the device in FIG. 1 partially disassembled;

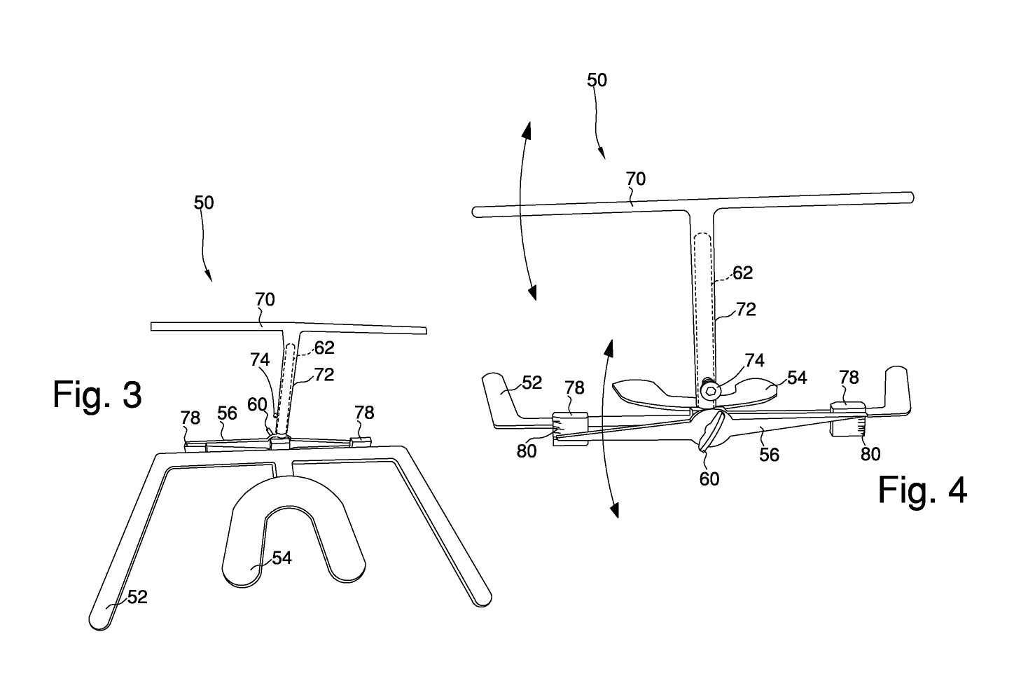

FIG. 3 shows a three-dimensional view from behind of a bow according to the invention;

FIG. 4 shows a three-dimensional view from the front of the bow according to the invention in FIG. 3;

FIG. 5 shows a three-dimensional view of a known articulator;

FIG. 6 shows a schematic front view of the articulator in FIG. 5 as modified by the device in FIG. 1;

FIG. 7 schematically shows an ideal face and some reference planes;

FIG. 8 schematically shows a real face and some reference planes;

FIG. 9 schematically shows a variation of the device;

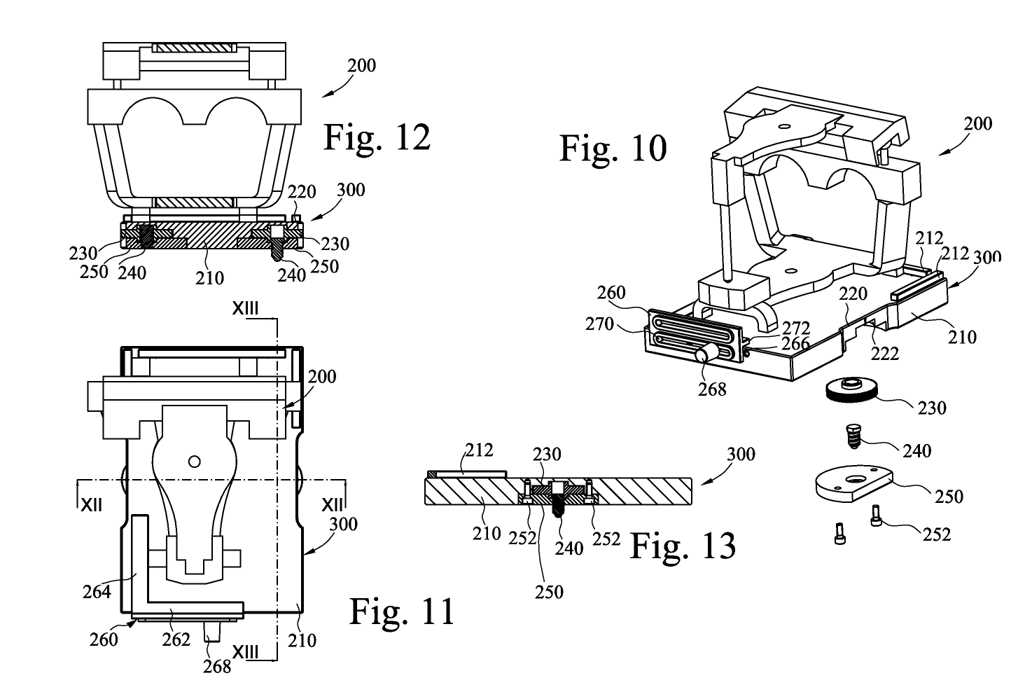

FIG. 10 schematically shows in perspective and in an exploded view a variation of the device in the form of an inclinable support accessory for articulator;

FIG. 11 shows a plan view of the variation in FIG. 10;

FIG. 12 shows the variation in FIG. 10 in cross-section according to the plane XII-XII;

FIG. 13 shows the variation in FIG. 10 in cross-section according to the plane XIII-XIII;

A device according to the invention is formed by a regulator foot 10 which comprises a hollow cylindrical body 12, elongated along an axis X, from which two arms 14,16 separated at a certain distance from each other jointly extend -along an axis Y perpendicular to the axis X. The arm 14 extends from one end of the body 12, while the opposite arm 16 is distanced from the base (or free edge) 15 of the body 12.

The body 12 has a pass-through axial cavity 13 along the axis X in which a pin 40 can be housed with minimum play, the pin 40 being provided at one end with a row of notches or incisions 42 on its lateral surface.

On the lateral surface of the body 12, on the side opposite the arms 12, 14, there is an internally threaded portion (or element) 20 (e.g. a nut welded to the body 12) which a screw 32 can be screwed into, along the axis Y, the shank of which may selectively project inside the cavity 13. To such purpose the body 12 is laterally perforated at the point of such element 20.

The arm 14 is bored and internally threaded from one side to the other so that a threaded dowel 30 can be inserted and screwed therein. The dowel 30 is orientated in such a way that by screwing it or unscrewing it moves further towards or away from the opposite arm 16 projecting from the arm 14 inside the empty space separating the two arms 14, 16. Essentially the distance between the arm 16 and the projecting head of the dowel 30 can be regulated by screwing the dowel 30.

The foot 10 is used to incline the articulator by the angle β as defined above, that is, to transfer the angle β to it and take it into consideration during modelling of the prosthesis.

The foot 10 is used as follows. One side of the base 50 of the articulator is placed between the arms 16, 14 (see the dotted line in FIG. 1) and is blocked in position by screwing the dowel 30 (so as to press it against the base 50). To bring the line TH parallel with the line EY, the pin 40 is inserted in the cavity 13, and made to project from the base 15 by a desired amount (see FIG. 1 dotted line). After which it is blocked by screwing the screw 32 into the body 12 so that its tip engages one of the notches 42 immobilising the pin 40. The part of the pin 40 projecting from the edge 15 increases the inclination of the base 50 of the articulator. FIG. 6 shows the articulator horizontal and then inclined (dotted line) by means of the foot 10.

To correctly establish an angle equal to β 3 on the articulator as measured on the patient, it is sufficient to measure the inclination of the articulator and find the notch 42 achieving the desired angle β.

For greater stability the operation may be repeated with another foot 10 applying it to the same side of the base 50 beside the former.

For greater ease of rotation, the screws 30, 32 and 74 may be of the wing type. The pin 40 may also be completely smooth (without the notches 42) and/or have a slight frustoconical shape, with the wider part coming out of the cavity 13.

The foot 10 has been described as a separate part of the articulator. It should be noted that thanks to the dowel 30 it can generally be attached to any known articulator, adapting it and attaching it to any base.

As a variation the foot 10 may be permanently incorporated on the articulator, or the articulator may be made with a built-in adjustable foot having the same function. The ability to adapt to various articulators is lost but the attachment operations rendered unnecessary. For example a screw or knob 90 acting as a foot may be applied in the base 150. The knob 90 has a thread 92 screwed into the base 150, and projects towards and contacts the plane P. Rotating the knob 90 it raises the articulator laterally so the angle between the plane P and the base 150 is adjustable (see arrows in FIG. 9 showing this variation schematically). The advantages of the first solution described so far are, above all, the stability and reproducibility thanks to the notches 42 or to a general graduation system.

To increase the precision of regulation of the foot 10, it would be convenient to already know which notch 42 to block the pin 40 on (or how far to turn the knob 190).

To such purpose, a transfer bow 50 for accurately reproducing the angle β on the articulator is shown in FIGS. 3 and 4. It is formed of a bow 52 to which a fork 54 is attached, above which some wax is placed which, heated and inserted in the patient's mouth, forms the cast of the teeth. A rocker arm 56 with a perpendicular pin 62 (shown by the dotted line) above which a sleeve 72 of a T-shaped reference 70 for the bipupillar plane is inserted telescopically, is attached to the bow 52 so as to swivel. A screwing key 60 is used to tighten the rocker arm 56 to the bow 52 or to make it oscillating in relation to it. A screw 74 can be screwed into the sleeve 72 to block the sleeve 72 in position on the pin 62. Two graduated blocks 78 with a scale consisting of notches 80 are present on the bow 52 near the ends of the rocker arm 56.

When the fork 54 is clenched in the patient's mouth, the key 60 is loosened and the benchmark 70 aligned with the bipupillar plane of the patient, if necessary the vertical position of the benchmark 70 being regulated in height on the pin 62. Once the relative positions of the fork 54 and the benchmark 70 have been fixed by tightening the screw 74 and the key 60, it is sufficient to read the scale of the blocks 78 indicated by the tip or wire of the rocker arm 56 (e.g. counting the notches 80). The value measured is an index of the inclination between the fork 54 and the benchmark 70, that is, in conclusion, of the angle β.

The same inclination is then reproduced on the articulator, inclining the whole by the same angle β. Preferably, the graduated scale on the blocks 78 is congruous with or the same as that made on the pin 40, so as to have a perfect correspondence: the number of notches shifted on the blocks 78 corresponds to the number of notches in relation to a zero reference point in the pin 40. By so doing the entire articulator can be inclined by the same angle as that formed by the lying-position of the plane of the fork 54 and the bipupillar plane.

FIGS. 10-13 show another embodiment of the invention.

FIG. 10 shows an articulator 200 placed on top of an accessory 300 adapted for inclining it laterally.

The accessory 300 comprises a table or flat base plate 210 on which the articulator may be placed. The table 210 comprises raised edges 212, e.g. positioned so as to form a U, around nearly an edge of the base 210 acting so as to provide an abutment for the base of the articulator 200 and keep it in position. The edges 212 may be fixed or be adjustable in position, e.g. inserting pins in predefined holes on the base 210. Other positioning and/or blocking means between the back of the articulator 200 and the base 210 such as, for example, clamps, Velcro®, shaped male-female couplings etc., may also be used.

Positioning and/or blocking means are also present between the front of the articulator 200 and the base 210. As well as, for example, clamps, Velcro®, shaped male-female couplings etc, an abutment 260 adjustable in position may also be used. The abutment 260 is for example L-shaped, with two segments 262, 264 at right angles, so as to be able to touch two sides of the articulator base 200. The abutment 260 has a horizontal slit 270 in which there is inserted a pin 268 that can be screwed and tightened in one or more aligned holes 266 present on the edge of the base 210. The abutment 260 has a horizontal lip 272 facing towards the articulator 200 by which it rests on it.

By loosening the pin 268 the abutment 260 can be shifted along the front edge of the base 210, and once the desired position has been reached, the pin 268 is tightened by screwing to fix the position of the abutment 260 on the base 210.

One or each of the two sides of the base 210 has a small recess 220 in which a cavity is made to house rotatably a notched wheel 230, rotatable with a finger, so as to turn. The accessory 300 could however only have one wheel, so that we will describe only one side, but with two it enables inclination on its sides without turning the articulator by 180°.

The wheel 230 has a polygonal or, in any case, non-circular hole in its centre, which a complementarily-shaped head of a screw 240 is inserted in so as to slide. A plate 250 is attached to the bottom of the table 210 by two screws 252 and keeps the wheel 230 trapped in the cavity 222 but free to rotate. The plate 250 has a hole with thread, corresponding to that of the screw 240 which traverses it in the latter hole.

The accessory 300 is used as follows. The articulator 300 is placed on the base 210 abutting it against the edges 212. By rotating a wheel 230 the screw 240 is screwed into the plate 250 in one direction or the other, so that the screw 240 projects more or less from the underside of the plate 250. The variable projection of the screw 240 modifies the inclination of the corresponding side of the base 210 in relation to its support plane and, definitely, inclines the articulator 200 laterally.

“Laterally” means according to the movement shown by the dotted line in FIG. 6.

FIG. 12 shows, for example, two screws 240 in different positions, retracted in the base 210 on the left, and extracted on the right.

1. A device for adjusting an inclination of an entire articulator in relation to a support plane, comprising:
a support element on said plane,
a fastening device connected to the articulator, and
a mechanism configured to adjust a distance between the fastening device and the support element.

2. Device according to claim 1, wherein the fastening device is non-permanent.

3. Device according to claim 1, wherein the fastening device comprises an adjustable-clamp structure.

4. Device according to claim 1, wherein the fastening device comprises an adjustable telescopic structure.

5. Device according to claim 1, further comprising:
a foot body,
a movable element in relation to the foot body adapted to rest on said plane to act as a support point,
a first selective-blocking device configured to fix the position of the movable element in relation to the foot body,
a fork-shaped extension which extends from the foot body and is adapted for contacting and/or receiving a portion of the articulator.

6. Device according to claim 5, further comprising a second selective-blocking device configured to attach said portion of the articulator to the fork-shaped extension.

7. Device according to claim 6, further comprising:
a hollow body,
a pin movable in the cavity of the hollow body, the pin comprising surface irregularities,
a threaded element which can be screwed into a counter-threaded aperture in the hollow body so as to engage the pin at an irregularity and thus block the pin,
two extensions integral with the hollow body which are parallel and distanced from each other so as to receive a portion of the articulator in an empty space therebetween, and
a threaded element which can be screwed into a counter-threaded aperture of an extension so as to contact said portion when present and clamp said portion between the extensions.

8. Separate accessory for an articulator, comprising:
a base adapted for supporting the articulator in relation to a generic support plane, and
an adjusting device configured to laterally adjust the inclination of the base, and thereby of the overlying articulator.

9. Accessory according to claim 8, wherein said adjusting device comprises an element whose projection from the base is adjustable.

10. Accessory according to claim 9, wherein said adjusting device comprises an element operable to be rotated and cooperating with a linearly movable element which can be shifted inside a recess of the base.

11. Accessory according to claim 10, wherein the operable element comprises a wheel housed in the base, the wheel being integral with a threaded element which can be screwed more or less into an element fixed with respect to the base.

12. Accessory according to claim 8, wherein the base comprises a positioning device for the articulator.

13. Accessory according to claim 12, wherein said positioning device comprises raised edges in relation to the base.

14. Accessory according to claim 12, wherein said positioning device comprises raised edges which can be positioned in an adjustable manner in relation to the base.

15. Accessory according to claim 14, wherein one raised edge comprises a groove in which a blocking element is inserted and adapted to fasten the raised edge to the base.

16. Device according to claim 2, wherein the fastening device comprises an adjustable-clamp structure.

17. Device according to claim 2, wherein the fastening device comprises an adjustable telescopic structure.

18. Device according to claim 3, wherein the fastening device comprises an adjustable telescopic structure.

19. Device according to claim 2, further comprising:
a foot body,
a movable element in relation to the foot body adapted to rest on said plane to act as a support point,
a first selective-blocking device configured to fix the position of the movable element in relation to the foot body,
a fork-shaped extension which extends from the foot body and is adapted for contacting and/or receiving a portion of the articulator.

20. Device according to claim 3, further comprising:
a foot body,
a movable element in relation to the foot body adapted to rest on said plane to act as a support point,
a first selective-blocking device configured to fix the position of the movable element in relation to the foot body,
a fork-shaped extension which extends from the foot body and is adapted for contacting and/or receiving a portion of the articulator.
